(19) United States
(12) Patent Application Publication
(10) Pub. No.: US 2024/0393182 A1
(43) Pub. Date: Nov. 28, 2024

(54) TEMPERATURE INPUT/OUTPUT (I/O) MODULE WITH INTEGRATED THERMISTOR FOR COLD JUNCTION COMPENSATION

(71) Applicant: Rockwell Automation Asia Pacific Business Center Pte. Ltd., Singapore (SG)

(72) Inventors: Qiao Zhang, Singapore (SG); Chia Leong Chin, Singapore (SG); Rajesh Ramesh Shah, Singapore (SG)

(73) Assignee: Rockwell Automation Asia Pacific Business Center Pte. Ltd., Singapore (SG)

(21) Appl. No.: 18/201,152

(22) Filed: May 23, 2023

(51) Int. Cl. G01K 7/01; G01K 7/24

(52) U.S. Cl. CPC G01K 7/01; G01K 7/24

(57) ABSTRACT

An I/O module includes an I/O base comprising a printed circuit board including I/O circuitry. A removable terminal block is removably connected to and selectively separable from the I/O base. The removable terminal block includes a plurality of field wiring terminals. The I/O module further includes a plurality of contact pairs each including: (i) a first constituent contact connected to the removable terminal block and electrically connected to one of said terminals; (ii) a second constituent contact connected to the I/O base and electrically connected to the I/O circuitry. A first CJC sensor is connected to the I/O base and is operatively connected to the I/O circuitry. The first CJC sensor is thermally associated with and adapted to sense a temperature of at least a first one of said second constituent contacts.

### BACKGROUND INFORMATION

Temperature input/output (I/O) modules for industrial control systems often receive analog temperature input signals from remote temperature sensors and convert the received temperature signals to digital signals used by an industrial control system to monitor and control the system or process. The remote temperature sensor can be an RTD (Resistance Temperature Detector) sensor or can be a thermocouple temperature sensor. A thermocouple comprises two electrical conductors that are dissimilar metals. The two conductors are joined at one end, referred to as the hot junction because it is located where the temperature is to be sensed in or adjacent an industrial process or system. The two opposite free ends of the conductors are joined to respective terminals (referred to as the cold junction) of a removable terminal block (RTB) and the voltage differential between the free ends is sensed. When using a thermocouple, the temperature of this cold junction must be known to compensate for a thermoelectric voltage that is generated when the cold junction is at a temperature other than zero degrees Celsius (0° C.) due to the connection between the thermocouple conductors and the copper or other conductors to which the thermocouple conductors are connected.

Although an RTD can be highly accurate, stable, and can provide a linear response, the use of a thermocouple instead of an RTD can be desirable for many reasons including lower cost, faster response, a higher temperature range, and higher durability in harsh conditions often associated with complex industrial systems. As noted above, however, a thermocouple requires cold junction compensation (CJC) which has heretofore been accomplished by locating a CJC temperature sensor such as a thermistor or other temperature sensor (sometimes referred to herein generally as a “CJC sensor”) on or within the removable terminal block (RTB), either by connecting the CJC sensor externally between first and second terminals of the RTB or by permanently embedding the CJC sensor within the molded polymer or other structure of the RTB. When the RTB is separated from a base of the I/O module, the CJC sensor moves with the RTB and is thus also separated from the I/O module base.

In either case, whether the CJC sensor is connected externally to the terminals of the RTB or embedded within the RTB, the functionality of the RTB is reduced because at least two of the RTB terminals are dedicated to the CJC sensor or are eliminated to provide space for the CJC sensor and its connections. Furthermore, an RTB can sometimes include two spaced-apart CJC sensors to allow for the fact that temperature can vary between first and second locations of the RTB, in which case the conductors of two different thermocouples are connected to the RTB adjacent respective first and second CJC sensors to ensure that the sensed CJC temperature is accurate for each thermocouple. As such, external or embedded CJC sensor(s) limit the functionality of the RTB by reducing the availability of RTB terminals for other I/O connections. Furthermore, CJC sensor(s) connected to or embedded in an RTB require use of two contact pairs of the RTB and I/O module that operatively connect the RTB to the I/O module when the RTB is physically and electrically mated with the I/O module. Also, an RTB with one or more embedded CJC sensors must be specially manufactured and stocked, which increases costs for the manufacturer, distributor, and customer. Similarly, the use of an external CJC sensor that is connected to the RTB requires that the CJC sensor be supplied and connected during manufacture or in the field, which can increase the cost and complexity of supply and installation.

### BRIEF DESCRIPTION

In accordance with one aspect of the present development, an I/O module includes an I/O base comprising a printed circuit board including I/O circuitry. A removable terminal block is removably connected to and selectively separable from the I/O base. The removable terminal block includes a plurality of field wiring terminals. The I/O module further includes a plurality of contact pairs each including: (i) a first constituent contact connected to the removable terminal block and electrically connected to one of said terminals; (ii) a second constituent contact connected to the I/O base and electrically connected to the I/O circuitry. A first CJC sensor is connected to the I/O base and is operatively connected to the I/O circuitry. The first CJC sensor is operatively associated with and adapted to sense a temperature of at least a first one of said second constituent contacts.

In accordance with another aspect of the present development, an I/O module base includes a body adapted to selectively receive an associated removable terminal block. A printed circuit board assembly including I/O circuitry is connected to the body. A plurality of contact pair constituents are connected to the body and each is electrically connected to the I/O circuitry of the printed circuit board assembly, wherein each of the plurality of contact pair constituents is configured to mate electrically with an associated contact pair constituent connected to the associated removable terminal block. A first CJC sensor is connected to the printed circuit board assembly and operatively connected to the I/O circuitry. The first CJC sensor is operatively associated with and adapted to sense a temperature of at least a first one of said contact pair constituents of said body.

In accordance with another aspect of the present development, an I/O module includes an I/O module base including a printed circuit board and I/O circuitry. A removable terminal block is removably connected to and selectively separable from the I/O module base. The removable terminal block includes a plurality field wiring terminals that are operatively connected to the I/O circuitry when the removable terminal block is connected to the I/O module base. A first CJC sensor is physically connected to the I/O module base and operatively connected to said I/O circuitry. The first CJC sensor is adapted to sense a first temperature associated with at least a first one of said field wiring terminals of the removable terminal block, wherein the first CJC sensor is physically connected to the I/O module base both: (i) when the removable terminal block is physically connected to the I/O module base; and (ii) when said removable terminal block is physically separated from the I/O module base.

### BRIEF DESCRIPTION OF THE DRAWINGS

FIG. 1 (prior art) illustrates one example of a known industrial control system 110 for controlling a controlled system 140.

FIG. 2 (prior art) shows an input/output (I/O) module including a removable terminal block (RTB), wherein the RTB includes at least one embedded CJC sensor (shown as first and second embedded CJC sensors) for cold junction compensation.

FIG. 3 (prior art) is a side view of the I/O module of FIG. 2.

FIG. 4 (prior art) is a diagrammatic illustration of an I/O module such as that shown in FIGS. 2 & 3 including at least one CJC sensor embedded in the removable terminal block (only one embedded CJC sensor is shown to simplify the drawing).

FIG. 5 is a diagrammatic illustration of an I/O module provided in accordance with an embodiment of the present development including at least one CJC sensor located within the I/O module, itself, instead of being embedded in the removable terminal block (first and second CJC sensors are shown in the illustrated example).

### DETAILED DESCRIPTION

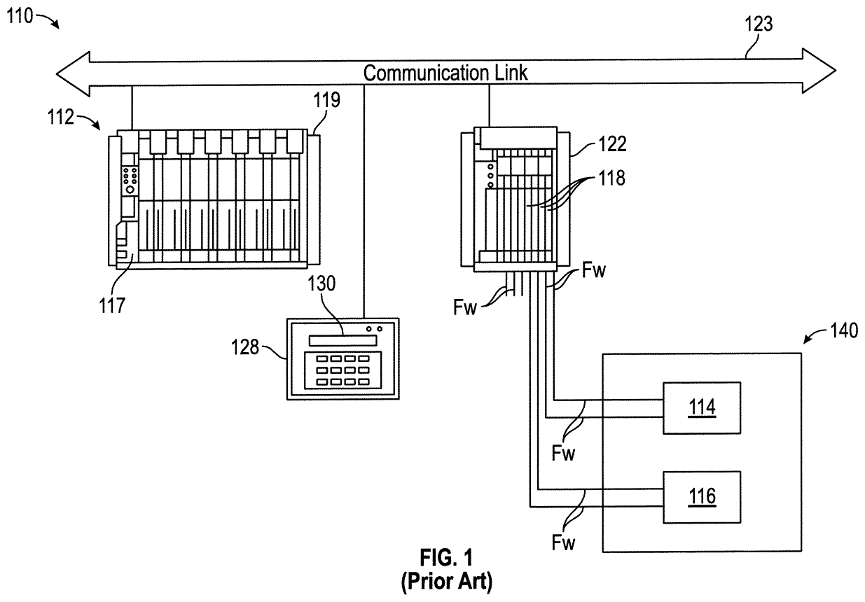

FIG. 1 illustrates one example of a known industrial control system 110 for controlling a controlled system 140. The illustrated and described industrial control system 110 and controlled system 140 are merely examples and other industrial control systems and controlled systems 140 are contemplated as part of the present disclosure. The terms “system” and “controlled system” can mean any device or machine or group of devices or machines, a process or a series of processes, or a combination of one or more devices, machines, and/or processes.

The industrial control system 110 comprises a programmable control system or “controller” 112 that controls the output status of one or a plurality of output devices 116 associated with the controlled system 140 based on the input status of one or a plurality of input devices 114 associated with the controlled system. To this end, the controller 112 includes a microprocessor-based processor or processor module 117 that executes a stored control program that defines the manner in which the output devices 116 are controlled based upon input received from the input devices 114.

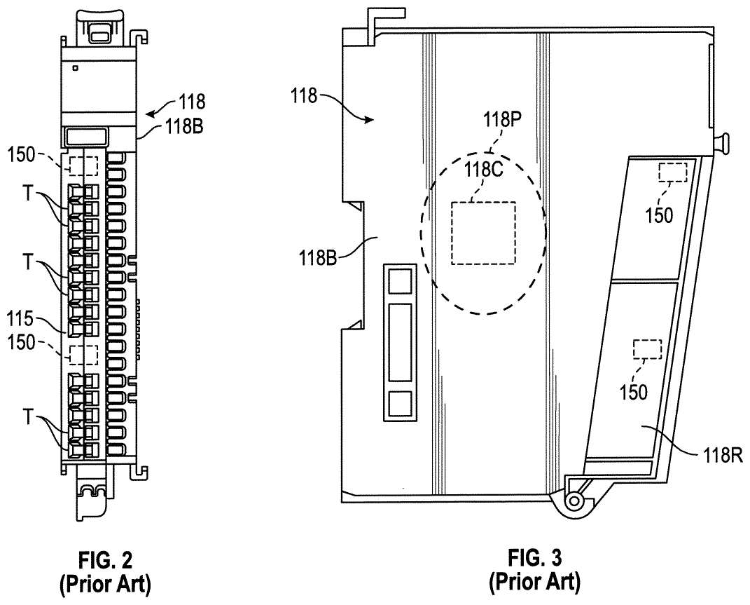

The processor module 117 communicates with the input and output devices 114,116 through one or more input/output modules or “I/O modules” 118. With reference also to FIGS. 2-4, the input and output devices 114,116 are each operably connected to an I/O module 118 using field wiring FW connected to the I/O module input or output channels through the terminals T (FIGS. 2, 3, 4) of a terminal block which can be a removable terminal block (RTB) 118R that can be selectively separated from the I/O module base 118B. The processor module 117 transmits a digital representation of the desired operational status of an output device 116 to the I/O module 118 connected to the particular output device 116.

As shown in FIG. 4, the I/O module base 118B includes or contains one or more printed circuit board assemblies (PCB) 118P that are connected to a body 118D of the I/O module base 118B and that comprise an electronic I/O circuit or I/O circuitry 118C including an analog-to-digital converter (ADC), a digital to analog converter (DAC), and/or other I/O circuitry for facilitating input from the input devices 114 and output to the output devices 116. Based on the digital representation of the desired operational status of the output device 116, the I/O circuit 118C produces and outputs an output control signal that is capable of driving or controlling the output device 116 in the desired manner as instructed by the processor module 117. Likewise, the processor module 117 receives a digital representation of the operational status of an input device 114 from the I/O module 118 that is connected to the particular input device 114. The I/O circuit 118C produces and outputs a digital data representation of the operational status of the input device 114 based on input status signals received from the input device 114 and communicates the digital data representation to the processor module 117. Those of ordinary skill in the art will recognize that the term “I/O module” is a general term that refers to input modules that receive input from one or more of the input devices 114, output modules that provide output to one or more of the output devices 116, and combined input and output modules that both receive input from one or more of the input devices 114 and also provide output to one or more of the output devices 116.

In the illustrated embodiment, the processor module 117 is disposed in a first or controller installation 119 which can be a first cabinet, rack, chassis, and/or modular assembly and the I/O module 118 is disposed in a separate second or I/O installation 122 which can be a second cabinet, rack, chassis, or modular assembly that can be adjacent the controller installation 119 or remote from the controller installation 119 (as shown). Communication between the processor module 117 and the I/O module(s) 118 occurs by way of a wired and/or wireless network or other communication link 123 such as an industrial ethernet network or another network. The industrial control system 110 also comprises other features such as an operator interface 128 and a message display 130.

In the known system of FIGS. 1-4, at least one of the input devices 114 is provided as an analog temperature sensor input device such as a thermocouple that requires cold junction compensation (CJC). As such, at least one of the I/O modules 118 is provided and/or configured as a temperature input module comprising a removable terminal block RTB (FIGS. 2-4) including at least one CJC sensor 150 that is embedded in or otherwise connected to the polymeric body of the removable terminal block 118R. In FIG. 4, the removable terminal block 118R is shown as comprising at least one CJC sensor 150. Typically, at least two spaced-apart CJC sensors 150 are embedded in the removable terminal block 118R, for example at opposite vertical ends when the removable terminal block 118R is vertically oriented, to sense and account for thermal variations in the operating environment of the I/O module 118. As is readily apparent in FIGS. 2 & 3, known systems that embed one or more CJC sensors 150 in the removable terminal block RTB include a reduced number of field wiring connection terminals T due to the space utilized by the one or more CJC sensors 150 and their related conductors, i.e., physical space in the body of the removable terminal block 118R that could otherwise be occupied by a field wiring connection terminal T and its conductor(s) is occupied by the CJC sensor 150 and its associated conductors, which reduces the terminals T available for the field wiring FW. When the removable terminal block 118R is physically separated from the I/O module base 118B, the embedded CJC sensors 150 move with the removable terminal block 118R since they are embedded in or otherwise connected to the removable terminal block 118R. As such, as shown in FIG. 4, when one or more CJC sensors 150 are embedded in the body of a removable terminal block 118R, first and second conductors S1,S2 of the CJC sensor 150 must be electrically connected to the I/O circuitry 118C of the I/O module base 118B respectively through a first contact pair CX1 (for the first CJC sensor conductor S1) and a second contact pair CX2 (for the second CJC sensor conductor S2), wherein the first constituent contact CX1a,CX2a of each of contact pair CX1,CX2 is operably connected to one of the sensor conductors S1,S2 within the removable terminal block 118R and the second constituent contact CX1b, CX2b of each of the first and second contact pairs CX1, CX2 is connected to the I/O module base printed circuit board 118P and operably connected to the I/O circuitry 118C. Since these first and second contact pairs CX1, CX2 are used for the CJC sensor conductors S1,S2, they are unavailable to be used as contact pairs for transferring data or signals related to the controlled system 140 between the terminals T of the removable terminal block RTB and the I/O circuitry 118C (see contact pairs CX3,CX4 connected to the terminals T).

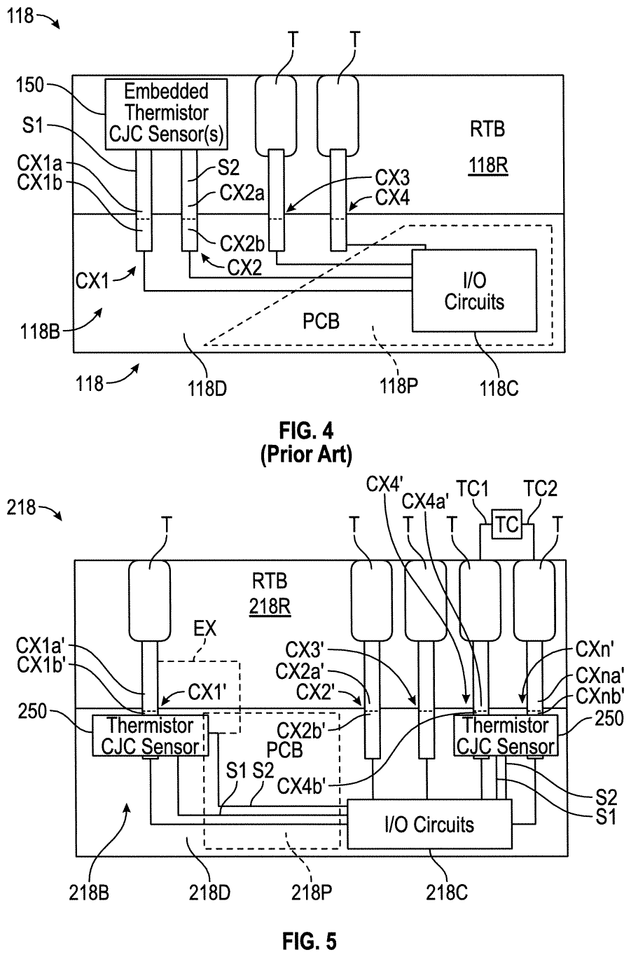

An I/O module 218 as shown in FIG. 5 is provided in accordance with an embodiment of the present development and overcomes the above-noted deficiencies and others associated with known I/O modules 118. Except as otherwise shown and/or described herein, the I/O module 218 is identical to the I/O module 118, and like components and features are identified with reference numbers that are 100 greater than those used in FIGS. 1-4 or are identified with a prime (′) designation in some cases. As with the known I/O module 118, the input and output devices 114,116 of a controlled system 140 can be operably connected to an I/O module 218 formed in accordance with the present development using field wiring FW connected to the I/O module input or output channels through the terminals T of a terminal block which can be a removable terminal block (RTB) 218R that can be selectively separated from an I/O module base 218B. The I/O module base 218B includes a body 218D. As with the known I/O module 118, the processor module 117 of system 110 transmits a digital representation of the desired operational status of an output device 116 to the I/O module 218 that is connected to the output device 116. Each terminal T of the removable terminal block 218R is operably electrically connected to the I/O circuit 218C of the I/O module base 218B through a terminal block contact pair CX1′, CX2′, . . . . CXn′ (generally CXn′) each comprising a respective first constituent contact CX1a′,CX2a′, . . . ,CXna′ (generally CXna′) operably connected to the terminal T of the removable terminal block RTB and a respective second constituent contact CX1b′,CX2b′, . . . , CXnb′ (generally CXnb′) operably connected to the printed circuit board assembly 218P of the I/O module base 218B. The respective first and second constituent contacts CXna', CXnb' mate to form the terminal block contact pair CXn′ when the removable terminal block 218R is physically operably connected to the I/O module base 218B such that the terminal T is operably electrically connected to the I/O circuit 218C through the printed circuit board assembly 218P. In this sense, the I/O module 218 comprises a plurality of contact pairs CXn′ each including: (i) a first constituent contact CXna′ connected to the removable terminal block 218R and electrically connected to one of said terminals T; (ii) a second constituent contact CXnb' connected to said I/O base 218B and electrically connected to said I/O circuitry 218C.

With continuing reference to FIG. 5, the I/O module base 218B includes one or more printed circuit board assemblies 218P located in or otherwise connected to the body 218D. The one or more printed circuit board assemblies 218C comprise an electronic I/O circuit or I/O circuitry 218C including an analog-to-digital converter (ADC), a digital to analog converter (DAC), and/or other I/O circuitry for facilitating input from the input devices 114 and output to the output devices 116. Based on the digital representation of the desired operational status of the output device 116 as received from the processor module 117, the I/O circuit 218C produces and outputs an output control signal that is capable of driving or controlling the output device 116 in the desired manner as instructed by the processor module 117. Likewise, the processor module 117 receives a digital representation of the operational status of an input device 114 from the I/O module 218 that is connected to the input device 114. In particular, the I/O circuit 218C produces and outputs a digital data representation of the operational status of the input device 114 based on input status signals received from the input device 114 and communicates the digital data representation to the processor module 117.

In contrast to the known I/O module 118 which includes at least one CJC sensor 150 embedded in or otherwise connected to the removable terminal block 118R, an I/O module 218 provided in accordance with the present development includes one or more CJC sensors 250 operably connected to the printed circuit board assembly 218P of the I/O module base 218B and thermally associated with one or more of the second constituent contacts CXnb′ (i.e., CX1b′, CX2b′, . . . ) to sense the temperature of the second constituent contact(s) CXnb′. The CJC sensor(s) 250 can be physically connected to or abutted with one or more of the second constituent contact(s) CXnb′ such as by a thermally conductive adhesive or otherwise physically connected to, abutted with, or otherwise thermally associated with one or more of the second constituent contact(s) CXnb′ such that the one or more second constituent contacts CXnb′ conduct heat directly into the CJC sensor 250. In another example, the CJC sensor 250 is not physically connected to or abutted with the second constituent contact(s) CXnb′ but is instead electrically connected to one or more of the terminals T such as by being electrically connected to the terminal T or its first constituent contact CXna′ or its corresponding second constituent contact CXnb′ by a copper or other electrically conductive metallic connection such as a contact, wire and/or trace as illustrated by the broken line EX in FIG. 5 such that the electrical connection EX provides a thermal pathway for heat from the terminal T and from the corresponding first and second constituent contacts CXna′, CXnb′ to be conducted into the CJC sensor 250 through the electrical connection EX. The electrical connection EX can be electrically connected to either one of the sensor conductors or leads S1,S2 of the CJC sensor 250 that operatively connect the CJC sensor 250 to the I/O circuitry 218C. As such, each CJC sensor 250 is thermally associated with one or more of the second constituent contacts CXnb′ (and thus also thermally associated with the corresponding first constituent contact CXna′ and the corresponding terminal T) to sense the temperature of the first constituent contact CXna′, the second constituent contact CXnb′, and the corresponding terminal T. Each CJC sensor 250 can be a thermistor or other temperature sensor. In this manner, the CJC sensor 250 senses the temperature of the second constituent contact(s) CXnb′ with which it is operably associated and provides and outputs an output signal that represents the temperature of the second constituent contact(s) CXnb′. The temperature value output by the CJC sensor 250 is used as a cold junction compensation value for cold junction compensation for a thermocouple TC that includes first and second conductors TC1,TC2 connected respectively to first and second terminals T of the removable terminal block 218R, wherein at least one and preferably both thermocouple conductors TC1,TC2 are connected to a terminal T that is associated with a CJC sensor 250, i.e., at least one and preferably both thermocouple conductors TC1,TC2 are connected to a terminal T that is electrically connected to a respective second contact constituent CXnb′ associated with a CJC sensor 250 that senses the temperature of the respective second constituent contact CXnb′ which approximates the temperature of the RTB terminal T to which the thermocouple conductor TC1,TC2 is connected. The temperature sensed by the CJC sensor 250 will approximate the actual temperature of the corresponding RTB terminal T that is electrically connected to the second contact constituent CXnb' that is associated with the CJC sensor 250. When the removable terminal block 218R is operably connected to the I/O module base 218B, the temperature sensed by each CJC sensor 250 will be the same as or at least closely approximate the temperature of the removable terminal block terminal T connected to the corresponding first constituent contact CXna' of the mated contact pair CXn′ (CXna′,CXnb′). Each CJC sensor 250 can comprise a thermistor temperature sensor including first and second conductors S1,S2 that are operably connected to the I/O circuit 218C through the printed circuit board assembly 218P, independent of said plurality of contact pairs CXn′, i.e., the first and second CJC sensor conductors S1,S2 do not utilize or require a contact pair CXn′ to electrically connect to the I/O circuitry 218C of the I/O base 218B. Unlike the I/O module 118, each CJC sensor 250 remains within and physically connected to the I/O module base 218B when the RTB 218R is physically separated from the I/O module base 218B.

As is also shown in FIG. 5, an I/O module 218 provided in accordance with an embodiment of the present development can include multiple CJC sensors 250 connected to the printed circuit board assembly 218B of the I/O module base 218B, wherein each CJC sensor comprises a thermistor or other temperature sensor operatively associated with one or more of the second constituent contacts CXnb′ of the terminal block contact pairs CXn′ for sensing the temperature of the second constituent contact(s) CXnb′ wherein the sensed temperature by each CJC sensor 250 is used as a cold junction compensation value for a thermocouple TC connected to the corresponding RTB terminal T that is electrically connected with the second constituent contact CXnb′ associated with the CJC sensor 250. FIG. 5 also shows that a single CJC sensor 250 connected to the printed circuit board assembly 218P can be operatively associated with more than one second constituent contact CXnb′ for sensing the temperature of the multiple second constituent contacts CXnb.

Those of ordinary skill in the art will recognize that, unlike a known I/O module 118 of FIGS. 1-4, the CJC sensor 250 (or each CJC sensor 250) of the present I/O module 218 is (are) always physically connected to said I/O module base 218B and always operatively connected to the I/O circuitry 218C of the printed circuit board assembly 218P for all positions of the removable terminal block 218R, i.e., both when the RTB 218R is physically connected to the I/O module base 218B and also when the RTB 218R is physically separated from the I/O module base 218B.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

The following is claimed:

1. An I/O module comprising:
an I/O base comprising a printed circuit board including I/O circuitry;
a removable terminal block removably connected to and selectively separable from the I/O base, said removable terminal block comprising a plurality field wiring terminals;
a plurality of contact pairs each including: (i) a first constituent contact connected to the removable terminal block and electrically connected to one of said terminals; (ii) a second constituent contact connected to said I/O base and electrically connected to said I/O circuitry;
a first CJC sensor connected to said I/O base and operatively connected to said I/O circuitry, said first CJC sensor thermally associated with and adapted to sense a temperature of at least a first one of said second constituent contacts.

2. The I/O module as set forth in claim 1, wherein said first CJC sensor is thermally associated with and adapted to sense a temperature of said first one of said second constituent contacts and also is thermally associated with and adapted to sense a temperature of a second one of said second constituent contacts.

3. The I/O module as set forth in claim 2, further comprising a second CJC sensor connected to said I/O base and operatively connected to said I/O circuitry, said second CJC sensor thermally associated with and adapted to sense a temperature of at least a third one of said second constituent contacts.

4. The I/O module as set forth in claim 3, wherein said first and second CJC sensors each comprise a thermistor.

5. The I/O module as set forth in claim 1, wherein said first CJC sensor comprises a thermistor.

6. The I/O module as set forth in claim 1, further comprising a thermocouple, wherein said thermocouple comprises first and second conductors that are respectively connected to first and second terminals of said plurality of terminals of said removable terminal block, and wherein said temperature sensed by said first CJC sensor provides a cold junction compensation input value for said thermocouple.

7. The I/O module as set forth in claim 1, further comprising a second CJC sensor connected to said I/O base and operatively connected to said I/O circuitry, said second CJC sensor thermally associated with and adapted to sense a temperature of at least a second one of said second constituent contacts.

8. The I/O module as set forth in claim 7, wherein at least one of said first and second CJC sensors is thermally associated with and adapted to sense a temperature of at least a second one of said second constituent contacts.

9. The I/O module as set forth in claim 1, wherein said first CJC sensor comprises first and second conductors that are operatively connected to said I/O circuitry of said I/O base through said printed circuit board independent of said plurality of contact pairs.

10. The I/O module as set forth in claim 1, wherein said first CJC sensor is physically connected to said I/O base both: (i) when said removable terminal block is physically connected to said I/O base; and (ii) when said removable terminal block is physically separated from said I/O base.

11. An I/O module base comprising:
a body adapted to selectively receive an associated removable terminal block;
a printed circuit board assembly including I/O circuitry connected to the body;
a plurality of contact pair constituents connected to said body and each electrically connected to said I/O circuitry of the printed circuit board assembly, wherein each of said plurality of contact pair constituents is configured to mate electrically with an associated contact pair constituent connected to the associated removable terminal block;
a first CJC sensor connected to said printed circuit board assembly and operatively connected to said I/O circuitry, said first CJC sensor thermally associated with and adapted to sense a temperature of at least a first one of said contact pair constituents of said body.

12. The I/O module base as set forth in claim 11, wherein said first CJC sensor is thermally associated with and adapted to sense a temperature of said first one of said contact pair constituents and also is thermally associated with and adapted to sense a temperature of a second one of said contact pair constituents of said body.

13. The I/O module base as set forth in claim 12, further comprising a second CJC sensor connected to said I/O base and operatively connected to said I/O circuitry, said second CJC sensor thermally associated with and adapted to sense a temperature of at least a third one of said contact pair constituents of said body.

14. The I/O module base as set forth in claim 13, wherein said first and second CJC sensors each comprise a thermistor.

15. The I/O module base as set forth in claim 11, wherein said first CJC sensor comprises first and second conductors that are operatively connected to said I/O circuitry of said I/O base through said printed circuit board independent of said plurality of contact pair constituents.

16. An I/O module comprising:
an I/O module base comprising a printed circuit board including I/O circuitry;
a removable terminal block removably connected to and selectively separable from the I/O module base, said removable terminal block comprising a plurality field wiring terminals that are operatively connected to said I/O circuitry when said removable terminal block is connected to said I/O module base;
a first CJC sensor physically connected to said I/O module base and operatively connected to said I/O circuitry, said first CJC sensor adapted to sense a first temperature associated with at least a first one of said field wiring terminals of said removable terminal block, wherein said first CJC sensor is physically connected to said I/O module base both: (i) when said removable terminal block is physically connected to said I/O module base; and (ii) when said removable terminal block is physically separated from said I/O module base.

17. The I/O module as set forth in claim 16, wherein said CJC sensor comprises a thermistor.

18. The I/O module as set forth in claim 16, wherein:
said field wiring terminals of said removable terminal block are electrically connected to said I/O circuitry of said I/O module base through respective contact pairs when said removable terminal block is physically connected to said I/O module base;
each of said contact pairs comprises: (i) a first constituent contact physically connected to said removable terminal block and electrically connected to a respective one of said terminals; and
(ii) a second constituent contact physically connected to said I/O module base and electrically connected to said I/O circuitry; and, said first CJC sensor is thermally associated with and senses said first temperature of one or more of said second constituent contacts within said I/O module base.

19. The I/O module as set forth in claim 18, wherein said first CJC sensor is thermally associated with said one or more of said second constituent contacts within said I/O module base by being at least one of: (i) physically connected to the one or more second constituent contacts;
(ii) electrically connected to the one or more second constituent contacts.

20. The I/O module as set forth in claim 16, further comprising a second CJC sensor physically connected to said I/O base and operatively connected to said I/O circuitry, said second CJC sensor adapted to sense a second temperature associated with at least a second one of said field wiring terminals of said removable terminal block, wherein said second CJC sensor is physically connected to said I/O base both: (i) when said removable terminal block is physically connected to said I/O base; and (ii) when said removable terminal block is physically separated from said I/O base.
